(19) United States
(12) Patent Application Publication
(10) Pub. No.: US 2023/0162179 A1
(43) Pub. Date: May 25, 2023

(54) TECHNIQUES FOR TRANSACTIONS ASSOCIATED WITH NON-FUNGIBLE TOKENS (NFT) USING ARTIFICIAL INTELLIGENCE (AI) AND MACHINE LEARNING (ML)

(71) Applicant: Meta Platforms, Inc., Menlo Park, CA (US)

(72) Inventor: Zi Yu Daniel DENG, San Ramon, CA (US)

(73) Assignee: Meta Platforms, Inc., Menlo Park, CA (US)

(21) Appl. No.: 17/455,852

(22) Filed: Nov. 19, 2021

(51) Int. Cl. G06Q 20/38; G06Q 20/06

(52) U.S. Cl. CPC G06Q 20/3823; G06Q 20/3827; G06Q 20/3829; G06Q 20/065

(57) ABSTRACT

According to examples, a system for transacting of virtual assets and/or associated non-fungible tokens (NFT) utilizing artificial intelligence (AI) and machine learning (ML) techniques is described. The system may include a processor and a memory storing instructions. The processor, when executing the instructions, may cause the system to generate a virtual asset; generate a non-fungible token (NFT) associated with the virtual asset; and determine a contractual item to facilitate a transaction for the virtual asset and the non-fungible token (NFT). The processor, when executing the instructions, may then generate a badge associated with the non-fungible token (NFT); receive an appraisal associated with the virtual asset; generate a valuation for the virtual asset based on the appraisal; and facilitate the transaction for the virtual asset and the non-fungible token (NFT) based on the valuation.

### TECHNICAL FIELD

This patent application relates generally to electronic transactions and electronic commerce, and more specifically, to systems and methods for transacting of virtual assets and/or transactions associated with non-fungible tokens (NFT) utilizing artificial intelligence (AI) and machine learning (ML) techniques.

### BACKGROUND

Virtual assets are a relatively new form of collectibles that may offer similar use, enjoyment and satisfaction to “real-world” collectibles. In many instances, a virtual asset may typically be based on digital data. Virtual assets may offer various advantages that “real-world” collectibles may not offer, such as reduced energy consumption (e.g., during manufacturing) and resource consumption (e.g., during storage).

However, a robust market for virtual assets has yet to manifest. One reason may be that a market for virtual assets may be underdeveloped. Another reason may be absence of reliable authentication and/or appraisal services. For these reasons, an interested party may be reluctant to enter the virtual assets market.

Unfortunately, these market-oriented limitations may have prevented virtual assets from being readily accepted by the generally public. Moreover, they may also have foreclosed a possibility of replacing drawbacks associated with “real-world” collectibles with convenience and sustainability of virtual assets.

### BRIEF DESCRIPTION OF DRAWINGS

Features of the present disclosure are illustrated by way of example and not limited in the following figures, in which like numerals indicate like elements. One skilled in the art will readily recognize from the following that alternative examples of the structures and methods illustrated in the figures can be employed without departing from the principles described herein.

FIGS. 1A-B illustrate a block diagram of a system environment, including a system, that may facilitate transacting of assets and/or transactions associated non-fungible tokens (NFT) utilizing artificial intelligence (AI) and machine learning (ML) techniques, according to an example.

FIG. 2 illustrates a diagram of a blockchain including a non-fungible token (NFT) block, according to an example.

FIG. 3 illustrates a diagram of a blockchain block, according to an example.

FIG. 4 illustrates a diagram of a user interface of a virtual asset creation page, according to an example.

FIG. 5 illustrates a screen of a user device showing a badge associated with a non-fungible token (NFT), according to an example.

FIG. 6 illustrates a diagram of a badge page associated with a non-fungible token (NFT), according to an example.

FIG. 7 illustrates a diagram of an asset ownership graph (AOG), according to an example.

FIG. 8 illustrates a diagram of an engagement communication, according to an example.

FIG. 9 illustrates a block diagram of a computer system for transacting of assets and/or transactions associated non-fungible tokens (NFT) utilizing artificial intelligence (AI) and machine learning (ML) techniques, according to an example.

FIG. 10 illustrates a flow diagram of a method for transacting of assets and/or transactions associated non-fungible tokens (NFT) utilizing artificial intelligence (AI) and machine learning (ML) techniques, according to an example.

### DETAILED DESCRIPTION

For simplicity and illustrative purposes, the present application is described by referring mainly to examples thereof. In the following description, numerous specific details are set forth in order to provide a thorough understanding of the present application. It will be readily apparent, however, that the present application may be practiced without limitation to these specific details. In other instances, some methods and structures readily understood by one of ordinary skill in the art have not been described in detail so as not to unnecessarily obscure the present application. As used herein, the terms “a” and “an” are intended to denote at least one of a particular element, the term “includes” means includes but not limited to, the term “including” means including but not limited to, and the term “based on” means based at least in part on.

Collecting of items (or “collectibles”) has been a human endeavor since before the advent of civilization, and has provided use, enjoyment and satisfaction to many. Collectors may collect items for any number reasons. Examples include utility (i.e., use), speculation (i.e., profit-seeking) and personal sentiment.

In many instances, a desire to collect may be so strong that it may lead a collector to acquire an excessive amount of items. That is, an “urge” to collect may lead a collector to acquire so many items that it may become untenable or unreasonable. For example, in some instances, storing and maintaining the items may require significant effort and/or significant physical space, and have detrimental environmental impacts and may require excessive energy consumption. As a result, the collector may use and enjoy the items less and less, sometimes to the point where the items sit idle and remain unused.

Virtual assets are a relatively new form of collectibles. As used herein, a “virtual asset” may be comprised of one or more elements of digital data. Examples of the types of digital data that may be utilized to generate a virtual asset include, but are not limited to, digital images, digital videos, digital audio, digital text, digital objects (e.g., bitmaps) and augmented reality (AR), mixed reality (MR) and virtual reality (VR) objects.

In many instances, a virtual asset may offer similar use, enjoyment and satisfaction to “real-world” (non-digital) collectibles. In particular, similar to “real-world” collectibles, a user may own the virtual asset, interact or utilize the virtual asset, and deploy (e.g., display) the virtual asset in various contexts.

Virtual assets may offer various benefits that “real-world” collectibles may not offer. For example, virtual assets may be generated and stored via use of computing devices, and therefore may not require the resources required in manufacturing and maintenance of “real-world” collectibles. In addition, since virtual assets occupy no space in the physical world, resources required in display, storage and transfer of virtual assets may be less as well.

For these reasons, virtual assets may represent an opportunity to reduce energy and resource consumption by transferring a collector's “urge” for physical, “real-world” collectibles into virtual assets. Specifically, a robust market of virtual assets may offer collectors similar use, enjoyment and satisfaction as “real-world” collectibles, while being significantly more convenient and energy efficient.

However, a robust market for virtual assets has yet to manifest. In particular, the market for virtual assets has yet to generate “market confidence” required for users freely and smoothly transact for virtual assets. This may be for a number of reasons.

One reason may be that a market for virtual assets may be underdeveloped. Currently, virtual assets may be offered by and available to only those with special access or operating in a “niche” associated space. As such, a person seeking a virtual asset (i.e., demand) may not always connect with a person wishing to offer the virtual asset (i.e., supply).

Another reason may be absence of reliable authentication and/or appraisal. In many instances, due to the relative novelty of virtual assets, it may be difficult for market participants to properly evaluate and appraise these virtual assets. Moreover, in some instances, a vast number of virtual assets lacking “comparables” may render the process of appraising inconvenient and unreliable.

In some instances, a “domain specialist” may be consulted/utilized to appraise a virtual asset. However, typically, consulting a domain specialist may be a “one-on-one” process (i.e., not scalable) that may be particular to the virtual asset.

Unfortunately, these market-oriented limitations may have prevented virtual assets from being readily accepted by the generally public. Moreover, they may have further foreclosed the possibility of replacing drawbacks associated with “real-world” collectibles with convenience and sustainability that come with virtual assets. Accordingly, it may be desirable to introduce technologies that may address these limitations.

A technology that has had far-reaching and potentially revolutionary impacts in recent years has been blockchain technology. In some examples, a blockchain may include a list of cryptographically associated records (i.e., “blocks”). Blockchains may be implemented as a publicly distributed ledger that may typically be managed by a decentralized, distributed, and peer-to-peer computer-based network.

In some examples, each block may contain a cryptographic hash of the previous block (i.e., a “chain”). As a result, in many instances, blockchains may be resistant to modification as data in any given block may not be altered retroactively without altering all subsequent blocks. Specifically, for a transaction to be written to the blockchain, it must be “validated” via use of network nodes (i.e., “miners”) that may ensure validity of a transaction. Consequently, it may be appreciated that, in some instances, blockchain technology may be particularly suited for exchange of digital or non-digital assets.

In some examples, a blockchain may implement a “smart contract”. In some examples, a smart contract may be a machine-executable contract that may receive an input and, based on the input, may perform a particular action. In some examples, a smart contract may be utilized to govern transfers of goods, services, property and rights.

In some instances, blockchain technology may be utilized to implement use of a “token” to represent and/or transfer digital or non-digital assets. In some examples, a token implemented via blockchain may be fungible or non-fungible. A non-fungible token (NFT) may be a tokenized version of an asset that is unique from other tokens of a same or similar class. It may be appreciated that, in some instances, non-fungible tokens (NFT) may be particularly suited for identification and/or authentication of an asset. In particular, in many instances, a non-fungible token (NFT) associated with an asset (e.g., a virtual asset) may be used to indicate exclusivity of ownership and/or represent a uniqueness of the associated asset. Furthermore, in some instances, a non-fungible token (NFT) may be used to “abstract” a uniqueness and/or essence of an asset. That is, in some instances, the non-fungible token (NFT) may be utilized to symbolize or represent a meaning or sentiment associated with the virtual asset (e.g., to an owner).

Nevertheless, it may be said that non-fungible token (NFT) technology remains underutilized. Indeed, in many instances, a lack of access by the general public may have prevented development of a sustainable marketplace for non-fungible tokens (NFT) as well. Accordingly, it may be beneficial to utilize non-fungible tokens (NFT) to facilitate and support a market for virtual assets.

Systems and methods describe transacting of virtual assets and/or associated non-fungible tokens (NFT) utilizing artificial intelligence (AI) and machine learning (ML) techniques. As used herein, an “asset” may include any item or commodity that may be desired by a party (e.g., an individual, a group of individuals). Also, as used herein, a “virtual” asset may include any asset that may be a digital (i.e., electronically accessible) asset. Examples of virtual assets may include digital items comprised of text, image, video, and audio. It should be appreciated that, in many instances, the systems and methods may be deployed as part of a content platform (e.g., a social media platform). Furthermore, as used herein, a “transaction” may include any activity associated with a virtual asset, wherein examples may include (but not limited to) generating, offering (e.g., advertising), purchase and conversion of the virtual asset.

In some examples, to provide transacting of virtual assets and/or associated non-fungible tokens (NFT), the systems and methods may analyze various aspects of a virtual asset. In particular, in some examples, transacting of virtual assets and/or associated non-fungible tokens (NFT) may be determined based on various information associated with a virtual asset, including attributes associated with an asset, participants in a market, and a market or market segment that an asset may be associated with.

In some examples, the systems and methods may generate (i.e., “mint”) a non-fungible token (NFT) associated with a virtual asset. Moreover, in some examples, a virtual asset and an associated non-fungible token (NFT) may be associated with a badge. As will be discussed further below, the badge associated with the virtual asset and the non-fungible token (NFT) may be utilized for discovery and sharing of unique virtual assets and generating interaction associated with virtual assets.

In some examples and as will described in further detail below, the systems and methods may improve (i.e., increase) virtual asset and/or associated non-fungible token (NFT) accessibility and liquidity. In these examples, the systems and methods may provide virtual asset and non-fungible token (NFT) liquidity (i.e., conversions) by analyzing aspects of a prospective buyer and/or seller to determine a likelihood that each may interested in transaction associated with the virtual asset. Furthermore, in some instances, the systems and methods described may generate a virtual asset and/or an associated non-fungible token (NFT), curate a (new and unique) marketplace associated with the virtual asset, and enable a buyer to purchase the virtual asset and the associated non-fungible token (NFT).

The systems and methods described herein may be implemented in various contexts. So, in some examples, the systems and methods may generate virtual assets to “test” a product's viability (i.e., a “balloon test”). Furthermore, virtual assets also facilitate product enhancements based on user feedback (e.g., via crowdsourcing), in some cases even before the virtual asset may be created or issued. Furthermore, the systems and methods may include and accommodate to various new technologies, such as augmented reality (AR), mixed reality (MR) and virtual reality (VR). In particular, in some examples, the virtual assets may be “assembled”, thereby providing an opportunity for limitless variations and features as well. In addition, in some examples, the systems and methods may enable virtual assets to be created and issued as “limited edition”, and may enable brands, such as luxury brands, an opportunity to expand their luxury assets and their luxury brand into the digital space.

In some examples, the systems and methods may also provide appraisal services associated with virtual assets. In particular, in some examples, the systems and methods may enhance liquidity of virtual assets by providing appraisal functionalities that may be used to gather (i.e., “crowdsource”) and implement user opinions. In some examples, these opinions may then be utilized to generate a valuation for a virtual asset, which may then facilitate a transaction for the virtual asset between a first party and a second party. In some examples and as discussed further below, features provided by the systems and methods described may be implemented via use of a content platform (e.g., a social media platform).

In some examples, the systems and methods may provide an incentive to a user to provide assessment and appraisal functionalities associated with a virtual asset. That is, in some examples, upon selecting a user to provide an appraisal and receiving the appraisal, the systems and methods may further provide a disbursement (e.g., a payment) to the user. In some examples, the systems and methods may provide a disbursement to the user based on an accuracy of the provided estimate (i.e., how close your estimate is to final sale). In some examples, the systems and methods may administer the disbursement based on terms and conditions provided by a smart contract.

In some examples, the systems and methods may benefit various participants in a virtual assets market and increase demand and liquidity for virtual assets. For example, in the case of an owner of a virtual asset, the systems and methods may utilize social price discovery (e.g., crowdsourcing) to generate accurate and reliable appraisals, which may enable the owner to confidently offer their virtual asset for purchase. Also, in the case of appraisers, the systems and methods may provide merit-based Income opportunities for participants (i.e., an appraiser), wherein the participant may accumulate “credibility” (e.g., in specialized domains) and may be compensated for transactions associated with the virtual asset. In the case of content platforms, the systems and methods may provide increased engagement, in particular with users interested in non-fungible token (NFT) related assets. Furthermore, for content platform providers, the system and methods described may generate additional revenue as well.

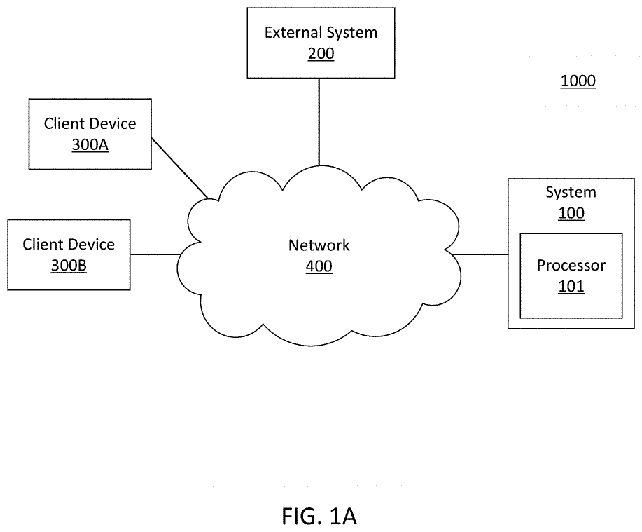

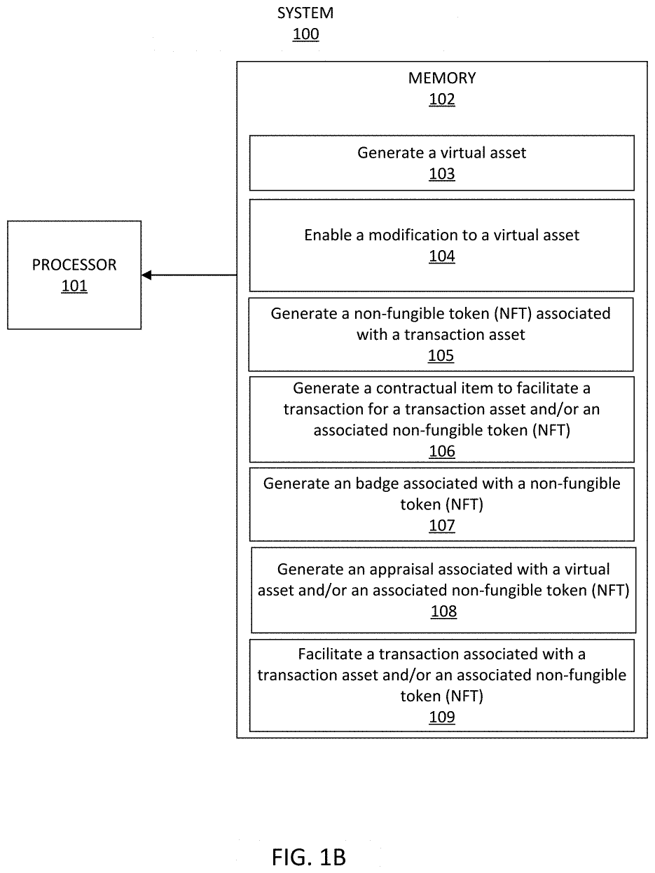

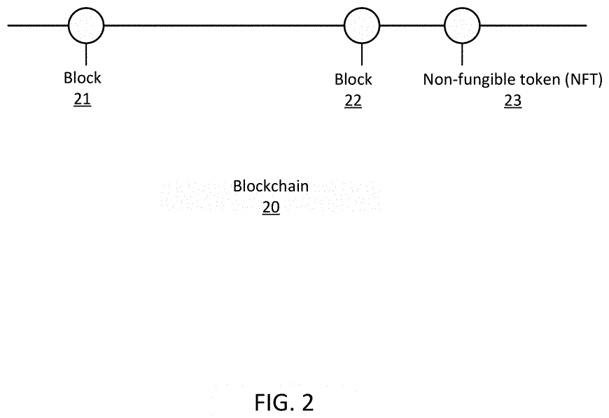

Reference is now made to FIGS. 1A-B. FIG. 1A illustrates a block diagram of a system environment, including a system, that may facilitate transacting of virtual assets and/or transactions associated non-fungible tokens (NFT) utilizing artificial intelligence (AI) and machine learning (ML) techniques. FIG. 1B illustrates a block diagram of the system that may facilitate transacting of virtual assets and/or transactions associated non-fungible tokens (NFT) utilizing artificial intelligence (AI) and machine learning (ML) techniques.

As will be described in the examples below, one or more of system 100, external system 200, user devices 300A-B and system environment 1000 shown in FIGS. 1A-B may be operated by a service provider to enable transactions for virtual assets and/or associated non-fungible tokens (NFT). It should be appreciated that one or more of the system 100, the external system 200, the user devices 300A-B and the system environment 1000 depicted in FIGS. 1A-B may be provided as examples. Thus, one or more of the system 100, the external system 200 the user devices 300A-B and the system environment 1000 may or may not include additional features and some of the features described herein may be removed and/or modified without departing from the scopes of the system 100, the external system 200, the user devices 300A-B and the system environment 1000 outlined herein. Moreover, in some examples, the system 100, the external system 200, and/or the user devices 300A-B may be or associated with a social networking system, a content sharing network, an advertisement system, an online system, and/or any other system that facilitates any variety of digital content in personal, social, commercial, financial, and/or enterprise environments.

While the servers, systems, subsystems, and/or other computing devices shown in FIGS. 1A-B may be shown as single components or elements, it should be appreciated that one of ordinary skill in the art would recognize that these single components or elements may represent multiple components or elements, and that these components or elements may be connected via one or more networks. Also, middleware (not shown) may be included with any of the elements or components described herein. The middleware may include software hosted by one or more servers. Furthermore, it should be appreciated that some of the middleware or servers may or may not be needed to achieve functionality. Other types of servers, middleware, systems, platforms, and applications not shown may also be provided at the front-end or back-end to facilitate the features and functionalities of the system 100, the external system 200, the user devices 300A-B or the system environment 1000.

It should also be appreciated that the systems and methods described herein may be particularly suited for digital content, but are also applicable to a host of other distributed content or media. These may include, for example, content or media associated with data management platforms, search or recommendation engines, social media, and/or data communications involving communication of potentially personal, private, or sensitive data or information. These and other benefits will be apparent in the descriptions provided herein.

In some examples, the external system 200 may include any number of servers, hosts, systems, and/or databases that store data to be accessed by the system 100, the user devices 300A-B, and/or other network elements (not shown) in the system environment 1000. In addition, in some examples, the servers, hosts, systems, and/or databases of the external system 200 may include one or more storage mediums storing any data. In some examples, and as will be discussed further below, the external system 200 may be utilized to store any information that may relate to transacting of virtual assets and/or associated non-fungible tokens (NFT) (e.g., user histories, preference information, etc.). As will be discussed further below, in other examples, the external system 200 may be utilized by a service provider (e.g., a social media application provider) as part of an data storage, wherein a service provider may access data on the external system 200 to provide transacting of virtual assets and/or associated non-fungible tokens (NFT).

In some examples, and as will be described in further detail below, the user devices 300A-B may be utilized to, among other things, transact for virtual assets and/or associated non-fungible tokens (NFT) as described herein. In some examples, the user devices 300A-B may be electronic or computing devices configured to transmit and/or receive data. In this regard, each of the user devices 300A-B may be any device having computer functionality, such as a television, a radio, a smartphone, a tablet, a laptop, a watch, a desktop, a server, or other computing or entertainment device or appliance. In some examples, the user devices 300A-B may be mobile devices that are communicatively coupled to the network 400 and enabled to interact with various network elements over the network 400. In some examples, the user devices 300A-B may execute an application allowing a user of the user devices 300A-B to interact with various network elements on the network 400. Additionally, the user devices 300A-B may execute a browser or application to enable interaction between the user devices 300A-B and the system 100 via the network 400.

Moreover, in some examples and as will also be discussed further below, the user devices 300A-B may be utilized by a user viewing content (e.g., advertisements) distributed by a service provider, wherein information relating to the user may be stored and transmitted by the user devices 300A to other devices, such as the external system 200. In some examples, and as will described further below, a user may utilize the user device 300A to provide preference information (e.g., a “like”) that may be utilized to determine that a virtual asset and/or associated non-fungible token (NFT) be created. In some examples, a content viewing history of a user utilizing the user device 300B may be utilized to offer a virtual asset and an associated non-fungible token (NFT) for purchase.

The system environment 1000 may also include the network 400. In operation, one or more of the system 100, the external system 200 and the user devices 300A-B may communicate with one or more of the other devices via the network 400. The network 400 may be a local area network (LAN), a wide area network (WAN), the Internet, a cellular network, a cable network, a satellite network, or other network that facilitates communication between, the system 100, the external system 200, the user devices 300A-B and/or any other system, component, or device connected to the network 400. The network 400 may further include one, or any number, of the exemplary types of networks mentioned above operating as a stand-alone network or in cooperation with each other. For example, the network 400 may utilize one or more protocols of one or more clients or servers to which they are communicatively coupled. The network 400 may facilitate transmission of data according to a transmission protocol of any of the devices and/or systems in the network 400. Although the network 400 is depicted as a single network in the system environment 1000 of FIG. 1A, it should be appreciated that, in some examples, the network 400 may include a plurality of interconnected networks as well.

In some examples, and as will be discussed further below, the system 100 may be configured to provide transacting of virtual assets and/or associated non-fungible tokens (NFT) utilizing artificial intelligence (AI) and machine learning (ML) techniques. Details of the system 100 and its operation within the system environment 1000 will be described in more detail below.

As shown in FIGS. 1A-B, the system 100 may include processor 101, a graphics processor unit (GPU) 101a, and the memory 102. In some examples, the processor 101 may be configured to execute the machine-readable instructions stored in the memory 102. It should be appreciated that the processor 101 may be a semiconductor-based microprocessor, a central processing unit (CPU), an application specific integrated circuit (ASIC), a field-programmable gate array (FPGA), and/or other suitable hardware device.

In some examples, the memory 102 may have stored thereon machine-readable instructions (which may also be termed computer-readable instructions) that the processor 101 may execute. The memory 102 may be an electronic, magnetic, optical, or other physical storage device that contains or stores executable instructions. The memory 102 may be, for example, random access memory (RAM), an Electrically Erasable Programmable Read-Only Memory (EEPROM), a storage device, an optical disc, or the like. The memory 102, which may also be referred to as a computer-readable storage medium, may be a non-transitory machine-readable storage medium, where the term “non-transitory” does not encompass transitory propagating signals. It should be appreciated that the memory 102 depicted in FIGS. 1A-B may be provided as an example. Thus, the memory 102 may or may not include additional features, and some of the features described herein may be removed and/or modified without departing from the scope of the memory 102 outlined herein.

It should be appreciated that, and as described further below, the processing performed via the instructions on the memory 102 may or may not be performed, in part or in total, with the aid of other information and data, such as information and data provided by the external system 200 and/or the user devices 300A-B. Moreover, and as described further below, it should be appreciated that the processing performed via the instructions on the memory 102 may or may not be performed, in part or in total, with the aid of or in addition to processing provided by other devices, including for example, the external system 200 and/or the user devices 300A-B.

In some examples, the memory 102 may store instructions, which when executed by the processor 101, may cause the processor to: generate 103 a virtual asset; enable 104 a modification to a virtual asset; generate 105 a non-fungible token (NFT) associated with a virtual asset; determine 106 a contractual item to facilitate a transaction for a virtual asset and/or an associated non-fungible token (NFT); generate 107 a badge associated with a non-fungible token (NFT); generate 108 an appraisal associated with a virtual asset and/or an associated non-fungible token (NFT); and facilitate 109 a transaction associated with a virtual asset and/or an associated non-fungible token (NFT).

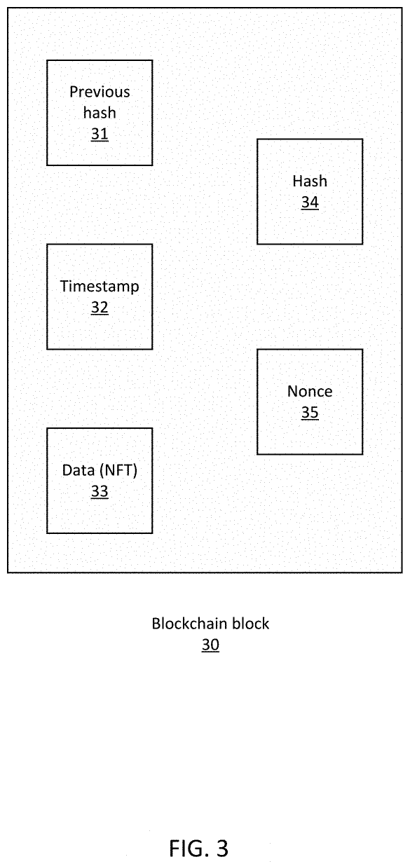

An example of a blockchain block 30 is illustrated in a FIG. 3. In some examples, the blockchain block 30 may include various elements, such as previous hash 31, timestamp 32, and data 33. As discussed above, the previous hash 31 may be cryptographic hash of a previous block that may be render an associated blockchain resistant to modification. In some examples, the timestamp 31 may indicate time and/or date of creation. In some examples, the data 33 may be a non-fungible token (NFT), such as the non-fungible token (NFT) generated via the instructions 105. In addition, in some examples, the blockchain block 30 may also include hash 34 and nonce 35 as well.

In some examples, and as discussed further below, the instructions 103-109 on the memory 102 may be executed alone or in combination by the processor 101 to provide transacting of virtual assets and/or associated non-fungible tokens (NFT) utilizing artificial intelligence (AI) and machine learning (ML) techniques. In some examples, the instructions 103-109 may be implemented in association with a content platform configured to provide content for users, while in other examples, the instructions 103-109 may be implemented as part of a stand-alone application.

Additionally and as discussed further below, although not depicted, it should be appreciated that to provide transacting of assets and/or associated non-fungible tokens (NFT), the instructions 103-109 may be configured to utilize various artificial intelligence (AI) and machine learning (ML) based tools. For instance, these artificial intelligence (AI) and machine learning (ML) based tools may be used to generate models that may include a neural network (e.g., a recurrent neural network (RNN)), natural language processing (NLP), a generative adversarial network (GAN), a tree-based model, a Bayesian network, a support vector, clustering, a kernel method, a spline, a knowledge graph, or an ensemble of one or more of these and other techniques. It should also be appreciated that the system 100 may provide other types of machine learning (ML) approaches as well, such as reinforcement learning, feature learning, anomaly detection, etc.

In some examples, the instructions 103 may generate a virtual asset. It should be appreciated that to generate the virtual asset, the instructions 103 may utilize various computer-implemented techniques, including natural language processing (NLP), artificial intelligence (AI) and deep learning techniques. Various aspects of generating a virtual asset via the instructions 103 are discussed further below.

In some examples, to generate a virtual asset, the instructions 103 may generate a virtual asset based on (i.e., using) one or more digital items. In other examples, the instructions 103 may generate an asset with one or more digital items “as is”. In some examples, the virtual asset may be associated with a non-digital asset. So, in one example, involving an antique clock, the instructions 103 may generate a virtual asset associated with the antique clock. In particular, in one example, the instructions 103 may utilize one or more photos, descriptive text and a user commentary (e.g., from a message board relating to antiques) to generate the virtual asset associated with the (physical) antique clock. In this example, the virtual asset may be, for example, a descriptive video describing the antique clock.

In some examples, to generate a virtual asset, the instructions 103 may gather and analyze information from any source. So, in some examples, the instructions 103 may gather information from any electronically available source that may include a content item. As used herein, “content item” may refer to any digital data. Examples of content items include, but are not limited to, digital data, digital images, digital video files, digital audio files, digital text and/or websites, applications, and streaming content.

In some examples, to generate a virtual asset, the instructions 103 may analyze information associated with a candidate asset to determine if the candidate asset may be suitable for generation of a virtual asset. As used herein, a “candidate asset” may include any asset that may be analyzed for association with a non-fungible token (NFT). Examples of various criteria that may be analyzed via the various techniques may include, but are not limited to, collectability, appeal, significance, rarity, scarcity, and exclusivity (i.e., one-of-kindness). It should be appreciated that the instructions 103 may utilize various artificial intelligence (AO), neural networking (NN) and machine learning (ML) techniques to analyze various information associated with a virtual asset and/or to determine suitability.

In some examples, to generate a virtual asset, the instructions 103 may gather and analyze various information associated with the virtual asset. In some instances, the types of various information may each be referred to as “attributes”. In some examples, the generation of the virtual asset may be based on attributes associated with the virtual asset. Examples of such attributes include scarcity, exclusivity and significance associated with the candidate asset.

In some examples, to generate a virtual asset, the instructions 103 may score one or more attributes associated with a candidate asset. So, in one example involving an antique clock being discussed on a group conversation in a social media forum, the instructions 103 may gather and analyze information such as “likes”, “shares” and comments to analyze the antique clock's popularity (i.e., an attribute). Additionally, in some examples, to generate the virtual asset, the instructions 103 may gather and analyze various information associated with participants in a market or information associated with a market or market segment that a virtual asset may be associated with.

In some examples, the instructions 103 may determine a score (i.e., an “attribute score”) that may be utilized to determine a candidate asset's suitability. Also, in some examples, to generate a virtual asset, the instructions 103 may implement a particular (computer) model associated with the virtual asset. In some examples, a virtual asset may be analyzed using a model for an associated market space.

In some examples, to determine a candidate asset's suitability, the instructions 103 may generate a suitability score for the candidate asset. In some examples, the instructions 103 may also utilize these suitability scores to determine a ranking. Furthermore, in some examples, the ranking may be used to determine may be used to determine suitable candidate assets. It may be appreciated that, in some examples, a suitability score may be adjusted based on various criteria. For example, in some examples, a suitability score may be adjusted based on, among other things, criteria such as an associated geography, a particular seasonality and/or time.

In some examples, the instructions 104 may enable a modification to a virtual asset. So, in some examples, prior to or upon determining a virtual asset, the instructions may modify or may enable modifications to generate the virtual asset. Various aspects of enabling modifications to a virtual asset via the instructions 104 are discussed further below.

In some examples, the instructions 104 may generate variations that may be used to modify/create a virtual asset. So, in some examples, the instructions 104 may provide (e.g., via a non-fungible token (NFT) creation page) one or more variations of a virtual asset to a user (e.g., a prospective owner/seller), wherein the instructions 104 may receive preference information (e.g., a selection) that may be used to create a virtual asset. Examples of variations that may be provided may be based on variations in colors, shapes, text, music and placement. It should be appreciated that to generate these variations, deep learning and artificial intelligence (AI) techniques may be implemented by the instructions 104.

In some examples, the instructions 104 may enable various modifications to a virtual asset. So, in an example involving a digital asset, examples of the various modifications may include zoom (i.e., in or out), rotation, and cropping. Also, in some examples, the instructions 104 may separate the virtual asset into two or more “layers”, wherein modifications may be applied to one or more of these layers of the virtual asset. Indeed, in some instances, the instructions 104 may enable disassembly and re-assembly of the virtual asset for modification purposes. Also, in some examples, the instructions 104 may implement various modifications that may operate in association with complementary technologies, such as augmented reality (AR), mixed reality (MR) and virtual reality (VR) techniques that may be associated with internet or “metaverse” related technologies. So, in one example, the modification to an image of a digital clock (i.e., the virtual asset) may be to modify the image to be accessible by a virtual reality (VR) technology device, such as a virtual reality (VR) headset. In another example, the instructions 104 may enable an aircraft mechanic to access a virtual asset associated with a vintage aircraft, and to view aspects of or “build” on to the virtual asset.

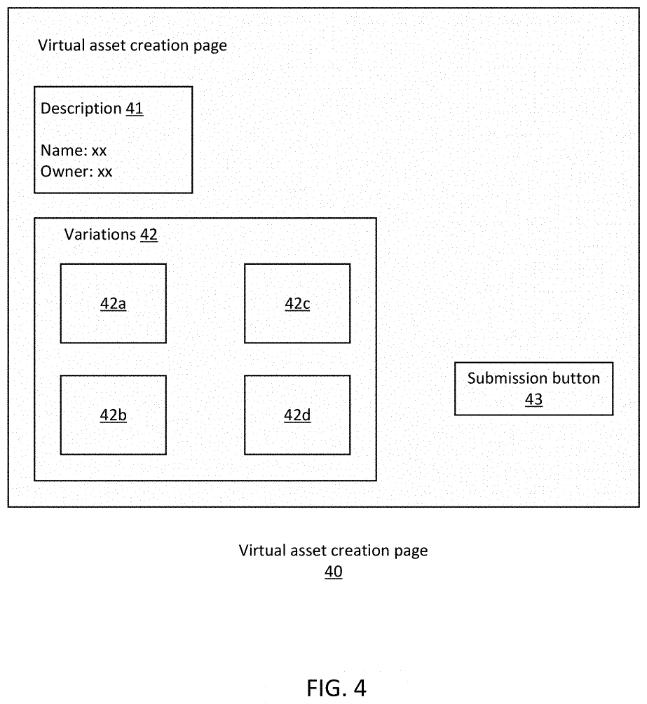

In some examples, the instructions 104 may provide a user interface that may enable a user to modify a virtual asset. In some examples, the instructions 104 may enable a party (e.g., a creator or seller) to input modifications to the virtual asset. Also, in some examples, the instructions 104 may enable a preview (e.g., a visual or audio preview) of a modified virtual asset that may be utilized by the prospective owner/seller to generate a virtual asset. An example of a user interface of a virtual asset creation page 40 is illustrated in FIG. 4. In some examples, the virtual asset page 40 may include an information portion 41, a variation selection portion 42 and a submission button 43. In some examples, the information portion 41 may include information such as name of an associated virtual asset and an owner/creator of the associated virtual asset. Furthermore, in some examples, the variation selection portion 42 may include variations of the virtual asset that the user may select from. In some examples, the variation selection portion 42 may include variation 42a, 42b, 42c and 42d. In some example, an owner/creator of the virtual asset may select (e.g., via a mouse-click) a preferred variation, and may select the submission button 43 thereafter to create the virtual asset.

In some examples, the instructions 105 may generate a non-fungible token (NFT) associated with a virtual asset. As discussed above, in some examples, the associated non-fungible token (NFT) may be generated (i.e., “born”) to represent and/or authenticate one or more aspects (e.g., ownership) of the virtual asset. Various aspects of generating a non-fungible token (NFT) associated with a virtual asset via the instructions 105 are discussed further below.

In some examples, the non-fungible token (NFT) may be generated concurrently with the virtual asset. In other examples, the non-fungible token (NFT) may be generated prior to generation of the virtual asset or generated after generation of the virtual asset.

In some examples, the instructions 106 may generate a contractual item to facilitate a transaction for a virtual asset and/or an associated non-fungible token (NFT). As used herein, a “contractual item” may relate to any aspect related to a virtual asset that may be specified with regard to a transaction (e.g., a purchase or sale). Various aspects of generating a contractual item to facilitate a transaction for a virtual asset via the instructions 106 are discussed further below.

Examples of contractual items that may be generated via the instructions 106 include specifications, terms and conditions that may be utilized to facilitate a transaction of a virtual asset. An example of a specification may be a suggested price or price range that may be associated with the virtual asset (e.g., based on analyzing sale information related to similar (virtual and non-virtual) assets). An example of a term that may be provided via the instructions may be an expiration date of an offer. An example of a condition may be restrictions in a manner of use that may be required of a buyer. In some examples, the contractual item(s) generated by the instructions 106 may be specified either automatically (e.g., via the instructions 106) or in combination with input from an associated party (e.g., a prospective owner/seller).

In some examples, a contractual item generated via the instructions 106 may be associated with one or more virtual assets. So, in some examples, the instructions 106 may generate (e.g., via a smart contract) one or more copies of a virtual asset. In other examples, the instructions 106 may generate one or more versions (i.e., different iterations of a same species) or variations (i.e., different species in a genus) of a virtual asset. It should be appreciated that, in some examples, the instructions 106 may generate a (dedicated) non-fungible token (NFT) for each copy or each version of a virtual asset.

In some examples, the instructions 106 may be utilized to facilitate an “artificial scarcity” associated with a virtual asset. In some examples, scarcity that may be provided may be time-based, wherein a non-fungible token (NFT) associated with a copy or version of a virtual asset may be “burned” (i.e., disappeared) after a specified period of time, thus signifying an end of a life cycle of for the virtual asset. Accordingly, in some examples, the instructions 106 may facilitate a shrinking supply of copies or versions of a virtual asset over time, which may increase desirability of the virtual asset. In some examples, the artificial scarcity may be implemented based on, among other things, criteria such as an associated geography, a particular seasonality and/or time.

In some examples, the instructions 106 may utilize a contractual item to generate a contract. In some examples, the generated contract may be a smart contract. Furthermore, in some examples, the smart contract may be recorded in a (blockchain) ledger of a non-fungible token (NFT) associated with the virtual asset. Examples of specifications, terms and conditions that may be implemented via use of smart contract are discussed further below.

In some examples, the instructions 106 may provide aspects related to ownership of a virtual asset. It should be appreciated that, in some instances, ownership of a virtual asset may include one or more parties. So, in a first example, the instructions 106 may generate a contractual item to administer ownership to be held by one party (e.g., a content creator). In another example, the instructions 106 may generate a contractual item to administer ownership to be held by multiple parties (e.g., creators), wherein the instructions 106 may determine and/or devise an ownership structure to be implemented amongst the multiple parties. In yet another example, ownership may be administered by the instructions 106 to be held by one or more creators of the virtual asset along with a service provider (e.g., a social media platform provider operating the system 100).

In some examples, the instructions 106 may provide contractual aspects related to modifications of a virtual asset. As used herein, a modification to a virtual asset may include any transformation of a virtual asset, including but not limited to a variation, limitation, enhancement, revision, update or customization of the virtual asset by a current or future owner.

In some examples, the instructions 106 may generate a contractual item to enable distribution of proceeds generated by a virtual asset to one or more parties. In some examples, the instructions 106 may provide distribution according to terms set out in a smart contract.

In some examples, the instructions 106 may generate a contractual item associated with distribution of a virtual asset. As used herein, “distribution” may include any type of transfer associated with a transaction for the virtual, including but not limited to exhibition, exchange, loan, purchase, sale or conversion of the virtual asset. So, in some examples, the instructions 106 may facilitate an exhibition of the virtual asset (e.g., via a loan) that may be for a particular location (e.g., an internet website, any and all metaverse location(s), etc.) for a specified period of time (e.g., a number of days). It should be appreciated that, in some examples, the instructions 106 may facilitate transfer of the virtual asset in parts (or pieces), such that the virtual asset may be “assembled” by a recipient upon delivery.

In some examples, with respect to distribution of a virtual asset, the instructions 106 may provide a contractual item associated with recipients of the virtual asset. In particular, the instructions 106 may generate the contractual item to specify one or more recipients of the virtual asset. So, in some examples, the instructions 106 may enable the virtual asset to be displayed to a targeted (i.e., limited) audience, whereas in other examples, the instructions 106 may enable the virtual asset to be distributed to recipients that may be selected (e.g., by an owner of the virtual asset).

Furthermore, in some examples, the instructions 106 may generate a contractual item that may relate to monetization of a virtual asset. For example, in some examples, the instructions 106 may facilitate and implement any type of monetization arrangement (e.g., a loan, a purchase, revenue sharing, etc.) with terms and conditions of the monetization arrangement specified by the contractual item. In some examples, the instructions 106 may implement various techniques, including artificial intelligence (AI), deep learning, and machine learning (ML) techniques, to distribute and/or monetize a virtual asset.

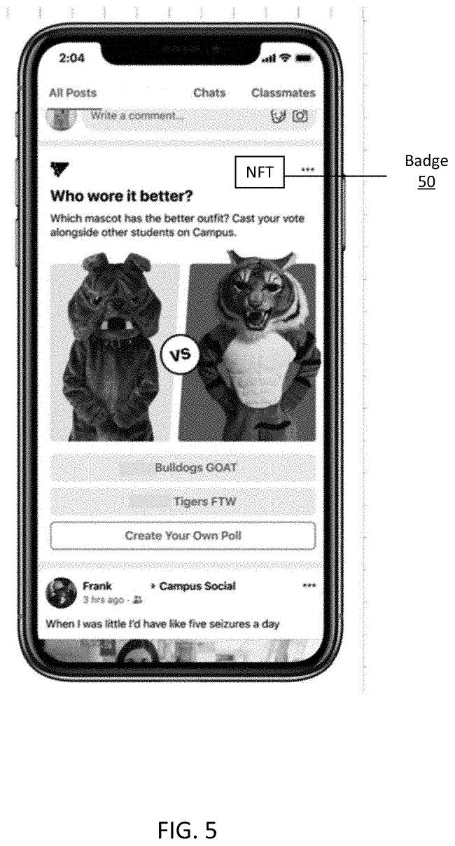

In some examples, the instructions 107 may generate a badge associated with a non-fungible token (NFT). As used herein, a “badge” may include any item of digital data that may be associated with and may identify a virtual asset and/or its non-fungible token (NFT). As discussed above, in some examples, the badge may identify (e.g., advertise) and/or authenticate a virtual asset and an associated non-fungible token (NFT), and may also facilitate a transaction associated with virtual asset. In particular, in some examples, the badge may be a digital representation of a virtual asset, wherein the badge may be utilized to (among other things) identify the virtual asset as unique. Indeed, in some examples, a badge may be employed as a “status” symbol that may provide a basis or an incentive to conduct a related transaction. Various aspects of generating a badge associated with a non-fungible token (NFT) via the instructions 107 are discussed further below. An example of a screen of a user device including a badge 50 associated with a non-fungible token (NFT) is illustrated in FIG. 5. In some examples, the badge 50 may be a selectable user interface element (e.g., an image, a bitmap image (GIF), etc.).

Returning now to FIG. 1B, in some examples, the badge generated via the instructions 107 may be based on some or all of an associated virtual asset (e.g., using content from the virtual asset itself) or an associated non-fungible token (NFT). In other examples, the badge may be generated independent of the associated virtual asset or the associated non-fungible token (NFT). Examples of badges that may be generated by the instruction 107 include images, video content, audio content and icons (e.g., selectable icons).

In some examples, the instructions 107 may generate a badge automatically, and in other examples, the instructions 107 may generate a badge upon request. In some examples, a badge generated via the instructions 107 may be associated with (e.g., may reference) any type of non-fungible token (NFT). In some examples, a badge generated via the instructions 107 may be associated with any type of blockchain ledger, whether public or private.

In some examples, the instructions 107 may generate a badge to provide and/or represent an ownership interest in an associated virtual asset. That is, in some examples, the instructions 107 may generate the badge to enable an owner of a virtual asset to display ownership in a variety of contexts and locations. Examples of the variety of contexts include, but are not limited to, display, advertising and authentication. Examples of the variety of locations may include, but are not limited to, content platforms, applications (e.g., email), and internet websites & chatrooms.

In addition, the instructions 107 may generate the badge to be utilized in a variety of other contexts as well. Examples of these contexts include, but are not limited to, generating engagement around the virtual asset (i.e., creating a following around the virtual asset) signifying limited or rare aspects of the virtual asset (e.g., a limited edition), and representing significant events or dates (e.g., an upcoming release date for an album).

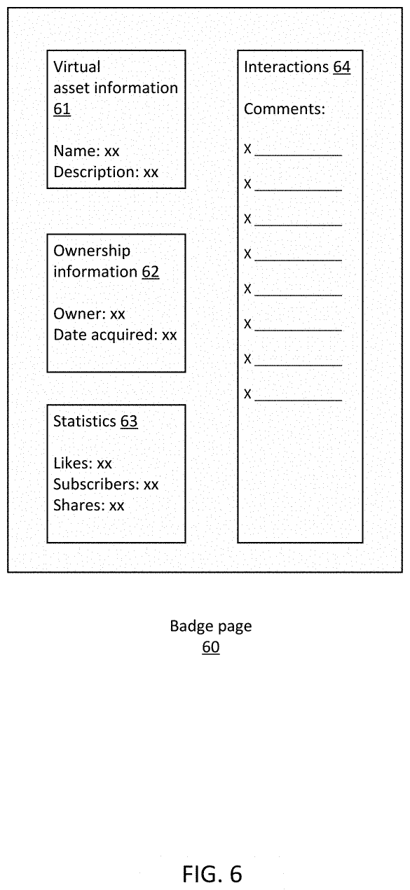

In some examples, upon engagement (e.g., selection) of a badge by a user (e.g., a viewer or prospective buyer), the instructions 107 may provide some or all of information associated with a virtual asset and/or an associated non-fungible token (NFT). For example, in some instances, the instructions 107 may provide this information on a badge “page” or non-fungible token (NFT) “page”. An example badge page 60 associated with a virtual asset and/or an associated non-fungible token (NFT) is illustrated in FIG. 6. In some examples, the badge page 60 may include virtual asset information 61, ownership information 62, statistics 63 and interactions 64. In some examples, the virtual asset information 61 may provide information associated with the virtual asset, such as name of the virtual asset and a description of the virtual asset. In some examples, the ownership information 62 may include information related to the owner of the virtual asset, such as the owner's name and/or a lineage of owners and date the virtual asset was acquired. In addition, in some examples, the statistics 63 may provide information associated with usage of the badge, such as likes, subscribes and shares. Also, in some examples, the interactions 64 may provide evidence of interactions with users that may have engaged the badge page 60. An example of the interactions 64 may be a comment section. It should be appreciated that the information, such as the information related to engagement (e.g., selections, comments, shares, etc.), associated with the badge may be utilized to for engagement and recommendation purposes.

Returning now to FIG. 1B, in some examples, a badge may be present during and/or part of each transaction or activity associated with a virtual asset. Accordingly, in some instances, a badge may be implemented by the instructions 107 to provide a “life cycle” (i.e. a record) for the virtual asset, beginning from creation (i.e., entry in a blockchain based ledger), throughout various transaction stages and ending with “sunset” (i.e., destruction or deletion of the virtual asset).

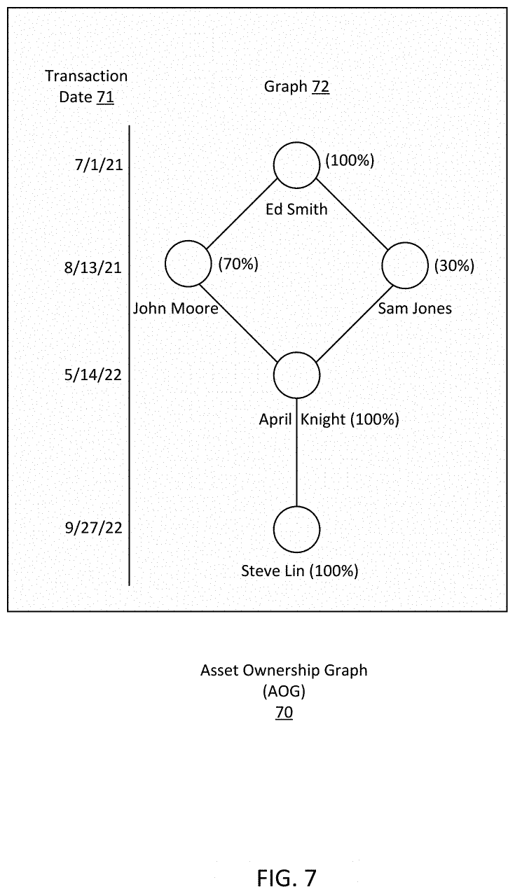

In some examples, the instructions 107 may enable generation of an asset ownership graph (AOG) associated with a badge and/or virtual asset. In some examples, an asset ownership graph may display (any and all) information associated with ownership of an associated virtual asset. In some examples, the asset ownership graph generated via the instructions 107 may provide information related owners of the virtual asset, a chronology of ownership, and purchase price of the virtual asset. Accordingly, in some examples, the badge and/or the asset ownership graph may be utilized to provide a “history” of the virtual asset. An example of an asset ownership graph (AOG) 70 is illustrated in FIG. 7. In some examples, the asset ownership graph 70 may include one or more transaction dates 71 and a graph 72 indicating ownership information.

Returning now to FIG. 1B, a badge generated by the instructions 107 may be utilized (e.g., by a viewer) to gather information associated with a virtual asset and an associated non-fungible token (NFT). Also, in some examples, the instructions 107 may employ the badges in a manner that may enable engagement.

In some examples, the instructions 108 may implement an appraisal associated with a virtual asset and/or an associated non-fungible token (NFT). That is, in some examples, the instructions 108 enable a user to submit information related to a virtual asset that may be utilized to appraise the virtual asset. As used herein, “appraise” may include any information associated with an opinion or evaluation of the virtual asset. In particular, in some examples, the instructions 108 may enable a user to provide an appraisal of a virtual asset to generate the valuation of the virtual asset. Various aspects of generating an appraisal associated with a virtual asset and an associated non-fungible token (NFT) via the instructions 108 are discussed further below.

In some examples, the instructions 108 may generate an engagement communication to a user that may enable to user to provide information (e.g., an appraisal) related to the virtual asset. More specifically, the instruction 108 may generate the engagement communication to enable the user to submit (e.g., an appraisal) related to the virtual asset. As used herein, an “engagement communication” may include any electronic communication (e.g., an email, an advertisement, an impression, etc.) that may be engaged by a user to receive or provide information related to an appraisal of a virtual asset. In some examples, an engagement communication may also be referred to as an “appraisal communication”.

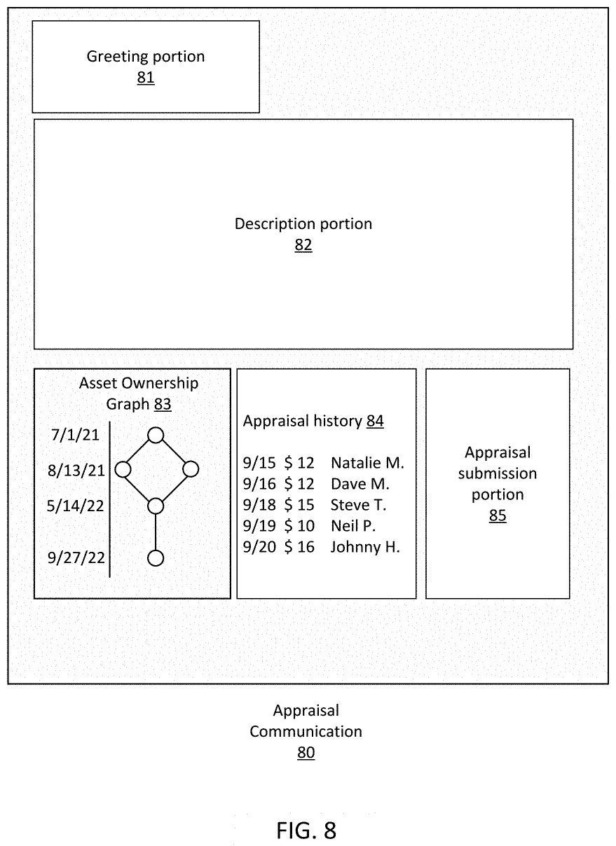

So, in a first example, the engagement communication generated by the instructions 108 may take the form of an advertisement (e.g., a badge) on social media that may be engaged (i.e., clicked) on by a user, which may provide various information related to a virtual asset and may enable the user to provide an appraisal for the virtual asset. In a second example, the engagement communication generated by the instructions 108 may take the form of an email to be transmitted an email address of a user, which may be opened by the user to receive various information related to a virtual asset and enable the user to provide an appraisal for the virtual asset. An example of an engagement communication 80 is illustrated in FIG. 8. In some examples, the engagement communication 80 may be an email communication. So, in some examples, the engagement communication may include a greeting portion 81, a description portion 82, an asset ownership graph (AOG) 83, an appraisal history 84 and an appraisal submission portion 85. In some examples, the greeting portion may include, among other things, a greeting to a recipient user and an explanation of why the recipient user may be receiving the engagement communication 80. In some examples, the description portion 82 may include a description of the virtual asset. The description of the virtual asset may include, among other things, specifications of the virtual asset and details of creation for the virtual asset.

In some examples, the asset ownership graph (AOG) 83 (e.g., as generated via the instructions 107) may display (any and all) information associated with ownership of the virtual asset. In some examples, the appraisal history 84 may include, among other things, one or more appraisals submitted by other users, timing (e.g., time and/or date submitted), and a name or username for each of the other users. In some examples, the appraisal submission portion 85 may enable the user to submit an appraisal associated with the virtual asset. Returning now to FIG. 1B, in a third example, the engagement communication generated by the instructions 108 may take the form of an entry in a digital “wallet” which may also be which may be engaged (i.e., clicked) to enable the user to receive various information related to a virtual asset and enable the user to provide an appraisal for the virtual asset.

In some examples, an engagement communication generated via the instructions 108 may be in a form of information package associated with the virtual asset. In some instances, the information package may also be referred to as an “appraisal kit”, and may include any information, items and parameters that may be utilized in generation of an appraisal for the virtual asset. In some examples, the instructions 106 may provide the information package to enable a prospective appraiser to preview or view related items and parameters, and if the prospective appraiser may be interested, may enable the prospective appraiser to provide an appraisal for the virtual asset. Examples of the types of information, items and parameters associated with the virtual asset include details about the virtual asset, purchase-related information (e.g., currency, a suggested appraisal value, etc.), time frames, tags and similar items (i.e., virtual assets), and transaction prices for similar items. In some examples, the instructions 108 may provide the information package to a particular user, while in other examples, the instructions 108 may publish the information as publicly available.

In some examples, the instructions 108 may receive information related to a virtual asset from a user. In particular, in some examples, the instructions 108 may receive information that may be associated with or may relate to an appraisal of the virtual asset. So, in some examples, the instructions 108 may receive an appraisal (i.e., an estimate) of the virtual asset. In other examples, the instructions 108 may receive an indication associated with an appraisal of the virtual asset, such as an indication (e.g., via a “like”) that an appraisal may be accurate or inaccurate. As discussed further below, the information related to the virtual asset received from the user may be utilized by the instructions 108 for various purposes, including determining an appraisal score for the user or determining a valuation for a virtual asset.

It should be appreciated that, as will be discussed further below, the instructions 108 may utilize various artificial intelligence (AI), neural networking (NN) and machine learning (ML) techniques to determine a destination, audience (i.e., user) or location to publish an engagement communication. That is, in some examples, the instructions 108 may utilize these various techniques to analyze various aspects of a virtual asset and a user to determine the destination, audience or location. Examples of information associated with a user include user behavior (e.g., purchase histories, browsing histories, etc.) and engagement (e.g., comments, likes, etc.). Examples of information associated with a virtual asset include information associated with similar or same assets and information associated with a user associated with the virtual asset (e.g., a seller, an owner, etc.).

In some examples, the instructions 108 may enable a user associated with a virtual asset to publish an engagement communication related to the virtual asset. So, in some examples, an owner (i.e., the user associated with the virtual asset) may publish an engagement communication associated with a virtual receive an appraisal for the virtual asset. In one particular example, the owner may publish an advertisement communication (i.e., the engagement communication), such as a video advertisement, on a content platform (e.g., a social media platform). Moreover, in some examples, the instructions 108 may enable publish an engagement communication to selected recipients as well.

In some examples, the instructions 108 may determine a cost associated with publishing of an engagement communication and/or a payments associated with a received appraisal with respect to a projected purchase price of a virtual asset. Specifically, in some instances and as discussed further below, the instructions 108 may enable advertisement costs associated with publishing of the engagement communication and/or payments associated with a received appraisal to be paid for from a purchase price of the virtual asset. In some examples, payment of the advertisement costs associated with publishing of the engagement communication may be administered by a smart contract (e.g., as generated via the instructions 106).

In some examples, the instructions 108 may determine that a user to be prompted to provide an appraisal of a virtual asset. That is, in some examples, the instructions 108 may implement a “push” model, wherein the instructions 108 may determine that a particular user is to be prompted to provide information associated with appraisal of an asset. It should be appreciated that, as will be discussed further below, the instructions 108 may utilize various artificial intelligence (AI), neural networking (NN) and machine learning (ML) techniques to determine the user to be prompted to provide an appraisal of the virtual asset.

To determine a user to be prompted to provide an appraisal of a virtual asset, the instructions 108 may, in some examples, generate an evaluation of a user. So, in some examples, the evaluation of the user generated by the instructions 108 may take the form an appraisal score for the user, wherein the appraisal score may indicate a likelihood that the user may provide an accurate information (e.g., an appraisal) associated with a virtual asset. It should be appreciated that, in some examples, the instructions 108 may generate multiple appraisal scores for a user. For example, in some instances, the instructions 108 may generate multiple appraisal scores for a user that may pertain to different asset classes. So, in one example, the instructions 108 may generate a first appraisal score for a user relating to shoes (i.e., a first asset class), and a second appraisal score for the user relating to antiques (i.e., a second asset class). Moreover, in some examples, the appraisal scores may be utilized by the instructions 108 to designate “experts” or “domain experts” associated with an asset class. As used herein, an “asset class” may include designation, classification or categorization that may be ascribed to a virtual asset. So, in one example, a user may have a first appraisal score for a first asset class, and may have a second (different) appraisal score for a second asset class.

In some examples, the instructions 108 may generate an appraisal score for a user based on various information. Examples of the various information utilized may be information associated with a user and information associated with a virtual asset. Examples of information associated with a user include user behavior (e.g., purchase histories, browsing histories, etc.) and engagement (e.g., comments, likes, etc.). Examples of information associated with a virtual asset include information associated with similar or same assets and information associated with a user associated with the virtual asset (e.g., a seller, an owner, etc.).

In some examples, the instructions 108 may generate a ranking of users. In particular, in some examples, the instructions 108 may generate a ranking of users based on appraisal scores. Moreover, in some examples, the instructions 108 may generate the ranking of users based on appraisal scores associated with an asset class. So, in some examples, for a particular asset class, the instructions 108 may generate a ranking of users that may be utilized to determine which user or users may, in some examples, be most likely to provide an accurate appraisal of a virtual asset.

In some examples, the instructions 108 may generate a tag associated with a virtual asset. As used herein, a “tag” may be any electronic impression or representation associated with the virtual asset that may be engaged by a user. In particular, in some examples, the tag may be a selectable word (e.g., a descriptive category) associated with the virtual asset that may be published in a location likely to be seen by a user and that may be engaged by the user. In another example, the tag may be a selectable user interface element (e.g., an image, a bitmap image (GIF), etc.) that may be engaged by the user as well. In some examples, the tag may be published by a user associated with the virtual asset (e.g., an owner). It should be appreciated that, in some examples, the instructions 108 may utilize various artificial intelligence (AI), neural networking (NN) and machine learning (ML) techniques to generate a tag associated with a virtual asset.

Furthermore, in some examples, the instructions 108 may enable a user to subscribe to a tag. In these examples, the instructions may generate a notification (e.g., to the user) that may alert the user of activity (e.g., an appraisal request) related to the tag (e.g., for a newly published virtual asset).

In some examples, the instructions 108 may analyze information associated with an appraisal received from a user. Examples of the type of information that may be evaluated include accuracy and timing. So, in a first example, the instructions 108 may analyze an (received) appraisal received from the user to determine how close (i.e., accurate) the appraisal may be to a purchase price. In a second example, the instructions 108 may analyze the appraisal received from the user to determine how long it took for a user to submit the appraisal received from the user. In some examples, the instructions 108 may increase or decrease (i.e., adjust) a disbursement or disbursement scheme associated with a user based on the analysis (e.g., how accurate one or more appraisals may be).

In some examples, the instructions 108 may analyze various information associated with an appraisal received from a user to generate various related information. Examples of this various related information may include a previous valuation associated with the virtual asset or to adjust an appraisal score for the user. In addition, in some examples, the instructions 108 may utilize the appraisal received from the user to modify (i.e., adjust) an appraisal score the user. Indeed, in some examples, as the instructions 108 may receive a plurality of appraisals relating to one or more virtual assets, the instructions 108 may analyze the plurality of appraisals to adjust an appraisal score for the user as it may relate to an associated asset class. Furthermore, in some examples, as the instructions 108 may receive a plurality of appraisals relating to one or more virtual assets, the instructions 108 may analyze the plurality of appraisals to adjust a ranking of users.

In some examples, the instructions 108 may disburse a payment associated with an appraisal received from a user. In some examples, these payments may be disburse based on evaluation of various criteria. Examples of the various criteria that may be analyzed to determine a payment to be disbursed include an accuracy of an appraisal (i.e., how close the appraisal is to a purchase or sales price), how long it took for a user to submit the appraisal or whether an appraisal satisfies a predetermined condition (e.g., that it was received from a particular region). It should be appreciated that to disburse the payment associated with the virtual asset, the instructions 108 may utilize a smart contract (e.g., as generated via the instructions 106). It should further be appreciated that disbursements issued by the instructions 108 may take various forms. Examples of the various forms include payments in currency (i.e., money), coupons and rights and/or privileges.

Indeed, in some examples, the instructions 108 may generate a disbursement scheme in order to incentivize aspects of appraisal generation. Examples of these aspects may include payments based on performance (i.e., accuracy) or loyalty (i.e., repeated and/or reliable submission of appraisals). It should be appreciated that, in some examples, the instructions 108 may utilize various artificial intelligence (AI), neural networking (NN) and machine learning (ML) techniques to generate a disbursement scheme associated with the virtual asset. For example, in some instances, the instructions 108 may structure a disbursement scheme to provide that an user (i.e., an appraiser) may receive payment based on an prospective one or more appraisals. So, in one instance where a payment may be based on one appraisal, the payment may be less (per unit) than a payment that may be made for a plurality of appraisals.

In some examples, the instructions 108 may disburse a payment based any transaction associated with the virtual asset. Examples of transactions include, but are not limited to, sale, resale, collaterization, investment, purchases, loans, rentals, downloads, sales, loyalty-based transactions and responses. That is, in some examples, for any and all transactions associated with a virtual asset, the instructions 108 may disburse a payment (e.g., a percentage) to user that may have provided an appraisal for the virtual asset.

In some examples, the instructions 108 may generate a valuation for a virtual asset. As used herein, a “valuation” may be a determination of worth associated with a virtual asset. In various examples, the instructions 108 may determine a valuation based on various metrics, such as currency, points or rights and/or privileges.

Indeed, in some examples, the instructions 108 may generate the valuation based on one or more (received) appraisals. It should be appreciated that, in some examples, the instructions 108 may utilize various artificial intelligence (AI), neural networking (NN) and machine learning (ML) techniques to generate the valuation for the virtual asset. In particular, in some examples, the instructions 108 may generate one or more protocols (e.g., clustering), formulas and/or statistical methods associated with valuation methods that may be calculated to generate the valuation for the virtual asset (e.g., upon closing of a selected time period for receipt of appraisals). So, in some examples, the instructions 108 may, for example, determine and/or dispense with outlier appraisals and utilize an evaluation of each appraisal utilized in order to generate the valuation associated with the virtual asset. It should be appreciated that, in some examples, the instructions 108 may provide various information related to the valuation associated with the virtual asset to a user, such as the owner or a prospective appraiser (e.g., via an information kit).

In some examples, the instructions 108 may utilize a smart contract associated with a virtual asset to generate a valuation of the virtual asset. So, in some examples, the instructions 108 may log (i.e., record) any submitted appraisal along with any additional information (e.g., identification of an appraiser who submitted the appraisal) on a blockchain ledger (i.e., “on-chain”) of a non-fungible token (NFT) or on an external storage device (i.e., “off-chain”), such as the external system 200. In some examples, some or all information associated with an appraisal may be published, for example, in an information kit or an engagement communication.

Furthermore, in some examples, the instructions 108 may adjust (e.g., continuously) the valuation based on various criteria, such as incoming appraisal values. Moreover, in some examples, one or more adjusted valuations generated by the instructions 108 may be provided to one or more users, such as an owner or a prospective appraiser (e.g., in an engagement communication).

In some examples, the instructions 109 may facilitate a transaction associated with a virtual asset and/or an associated non-fungible token (NFT). That is, in some examples, the instructions 109 may facilitate a transaction of a virtual asset by matching one or more interested parties (i.e., potential buyers) with a seller or sellers of the virtual asset in order to complete a transaction (e.g., a conversion, a purchase, etc.). Accordingly, in some examples, the instructions 109 may increase liquidity of in a market for non-fungible token (NFT)-related virtual assets. Various aspects of facilitating a transaction associated with a virtual asset and an associated non-fungible token (NFT) via the instructions 109 are discussed further below.

In some examples, the instructions 109 may “make” a market that may match supply (i.e., sellers) with demand (i.e., buyers). It should be appreciated that numerous sellers may offer a wide variety of virtual assets and that numerous buyers may seek particular virtual assets. In some examples, the instructions 109 may implement various techniques, including artificial intelligence (AI), deep learning, and machine learning (ML) techniques, to match a first party (e.g., a seller) offering a virtual asset to a second party (e.g., a buyer) that may be interested.

In some examples, the instructions 109 may enable a first party (i.e., a seller) to publish information related to a virtual asset. So, in some examples, the instruction 109 may enable the first party to generate and publish information related to the virtual asset and/or an associated non-fungible token (NFT). Example transactions may include a listings, auctions and sales.

It should be appreciated that, in some examples, the instructions 109 may publish information related to a virtual asset in the form of a content item that may be distributed to interested parties (e.g., an advertisement). In some examples, the content item may include text, audio and/or video. In some examples, the instructions 109 may utilize any information associated with the virtual asset (e.g., information generated and/or accessed via the instructions 103-107) to generate the content item.

In some examples, the instructions 109 may generate and implement an outreach plan to publish information related to a virtual asset. Example outreach plans may include marketing plans and advertising plans. So, in some examples, the instructions 109 may generate an advertising plan that may be implemented to engage other parties with respect to the virtual asset. In particular, in one example, the instructions 109 may implement an advertising plan using one or more social media platforms, wherein one or more content items may be published to engage users on the social media platform with respect to the virtual asset.

In some examples, the instructions 109 may analyze various aspects, including aspects of one or more parties (e.g., prospective buyers) or a virtual asset, to determine an interest in a virtual asset. That is, in some examples, the instructions 109 may analyze various aspects of a party to determine if they may be interested in a virtual asset and/or an associated non-fungible token (NFT). Additional examples of these various aspects that may be analyzed include demographic information (e.g., age, gender, etc.), location (e.g., city or country of residence) and occupation (e.g., student, professional, etc.). In some examples, the instructions 109 may analyze various aspects of the virtual asset (e.g., any information generated and/or accessed via the instructions 103-107) to determine an interest in a virtual asset as well. Examples of the various aspects that may be analyzed include market segment, pricing information, significance and rarity. It should be appreciated that to analyze one or more parties and one or more transactions items to determine an interest, various computer-implemented techniques may be utilized, including artificial intelligence (AI), natural language processing (NLP), machine learning (ML) and neural networking (NN) techniques.

In some examples, to engage to an interested party, the instructions 109 may utilize and operate in association with a content platform (e.g., a social media platform). For example, in some instances, the instructions 109 may utilize information from a recommendation algorithm affiliated with a content platform to analyze prospective viewers/buyers. Examples of information that may be made available by a content platform and/or recommendation algorithm may be content preferences (e.g., of prospective buyer and those similarly situated), purchasing histories and trends.

In some examples, upon determining that a party may be interested (e.g., a potential buyer), the instructions 109 may provide (i.e., publish) a content item associated with a virtual asset to the interested party. In some instances, the content item may take the form of an advertisement, wherein the interested party may engage (e.g., select, view) the advertisement to facilitate a transaction. In some examples, an interested party may utilize a content item to convey interest (e.g., select a “Learn more” button). In one example, the content item may be an advertisement (e.g., an image and text) that may be placed by the instructions 109 in a social media “feed” of a user that may be interested in the virtual asset (e.g., explicitly request a virtual asset be associated with a non-fungible token (NFT)).

In some examples, the instructions 109 may facilitate a conversion associated with a virtual asset. As used herein, a “conversion” may include any activity associated with a virtual asset that a first party and a second party may jointly conduct. Examples of conversions include, but are not limited to, purchases, downloads, sales, and responses. It should be appreciated that in some examples and as described further below, the seller patient may implement terms and restrictions of use (e.g., in a smart contract associated with the non-fungible token (NFT)).

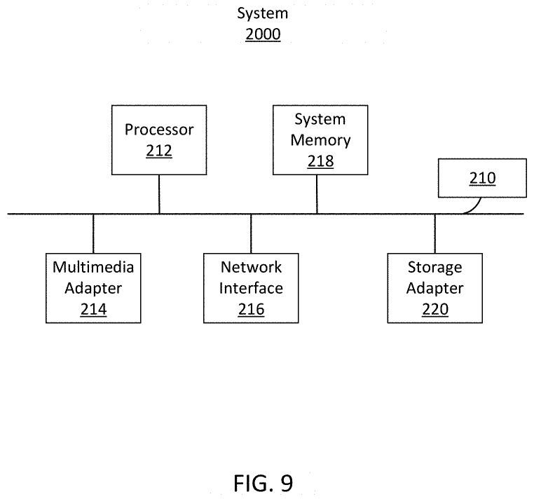

FIG. 9 illustrates a block diagram of a computer system for transacting of assets and/or transactions associated non-fungible tokens (NFT) utilizing artificial intelligence (AI) and machine learning (ML) techniques, according to an example. In some examples, the system 2000 may be associated the system 100 to perform the functions and features described herein. The system 2000 may include, among other things, an interconnect 210, a processor 212, a multimedia adapter 214, a network interface 216, a system memory 218, and a storage adapter 220.

The interconnect 210 may interconnect various subsystems, elements, and/or components of the external system 200. As shown, the interconnect 210 may be an abstraction that may represent any one or more separate physical buses, point-to-point connections, or both, connected by appropriate bridges, adapters, or controllers. In some examples, the interconnect 210 may include a system bus, a peripheral component interconnect (PCI) bus or PCI-Express bus, a HyperTransport or industry standard architecture (ISA)) bus, a small computer system interface (SCSI) bus, a universal serial bus (USB), IIC (I2C) bus, or an Institute of Electrical and Electronics Engineers (IEEE) standard 1394 bus, or “firewire,” or other similar interconnection element.

In some examples, the interconnect 210 may allow data communication between the processor 212 and system memory 218, which may include read-only memory (ROM) or flash memory (neither shown), and random access memory (RAM) (not shown). It should be appreciated that the RAM may be the main memory into which an operating system and various application programs may be loaded. The ROM or flash memory may contain, among other code, the Basic Input-Output system (BIOS) which controls basic hardware operation such as the interaction with one or more peripheral components.

The processor 212 may be the central processing unit (CPU) of the computing device and may control overall operation of the computing device. In some examples, the processor 212 may accomplish this by executing software or firmware stored in system memory 218 or other data via the storage adapter 220. The processor 212 may be, or may include, one or more programmable general-purpose or special-purpose microprocessors, digital signal processors (DSPs), programmable controllers, application specific integrated circuits (ASICs), programmable logic device (PLDs), trust platform modules (TPMs), field-programmable gate arrays (FPGAs), other processing circuits, or a combination of these and other devices.

The multimedia adapter 214 may connect to various multimedia elements or peripherals. These may include devices associated with visual (e.g., video card or display), audio (e.g., sound card or speakers), and/or various input/output interfaces (e.g., mouse, keyboard, touchscreen).

The network interface 216 may provide the computing device with an ability to communicate with a variety of remote devices over a network (e.g., network 400 of FIG. 1A) and may include, for example, an Ethernet adapter, a Fibre Channel adapter, and/or other wired- or wireless-enabled adapter. The network interface 216 may provide a direct or indirect connection from one network element to another, and facilitate communication and between various network elements.

The storage adapter 220 may connect to a standard computer-readable medium for storage and/or retrieval of information, such as a fixed disk drive (internal or external).

Many other devices, components, elements, or subsystems (not shown) may be connected in a similar manner to the interconnect 210 or via a network (e.g., network 400 of FIG. 1A). Conversely, all of the devices shown in FIG. 9 need not be present to practice the present disclosure. The devices and subsystems can be interconnected in different ways from that shown in FIG. 9. Code to implement the dynamic approaches for payment gateway selection and payment transaction processing of the present disclosure may be stored in computer-readable storage media such as one or more of system memory 218 or other storage. Code to implement the dynamic approaches for payment gateway selection and payment transaction processing of the present disclosure may also be received via one or more interfaces and stored in memory. The operating system provided on system 100 may be MS-DOS, MS-WINDOWS, OS/2, OS X, IOS, ANDROID, UNIX, Linux, or another operating system.

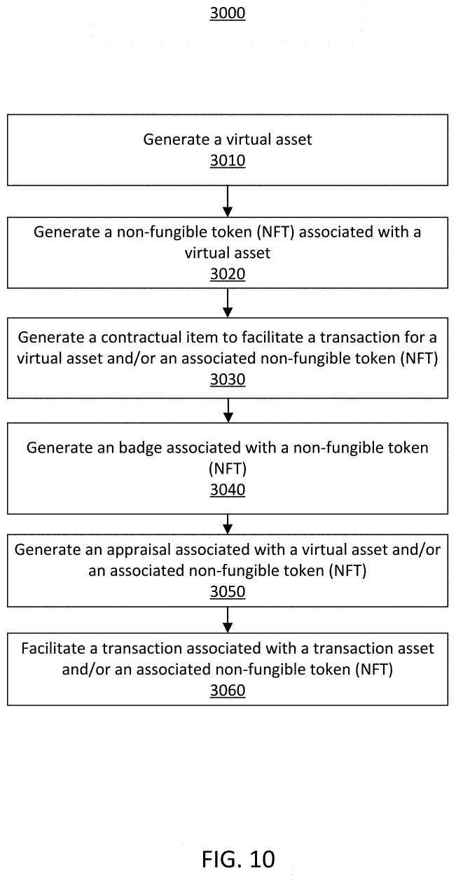

FIG. 10 illustrates a flow diagram of a method for transacting of virtual assets and/or transactions associated non-fungible tokens (NFT) utilizing artificial intelligence (AI) and machine learning (ML) techniques. The method 3000 is provided by way of example, as there may be a variety of ways to carry out the method described herein. Each block shown in FIG. 10 may further represent one or more processes, methods, or subroutines, and one or more of the blocks may include machine-readable instructions stored on a non-transitory computer-readable medium and executed by a processor or other type of processing circuit to perform one or more operations described herein.

Although the method 3000 is primarily described as being performed by system 100 as shown in FIGS. 1A-B, the method 3000 may be executed or otherwise performed by other systems, or a combination of systems. It should be appreciated that, in some examples, to provide transacting of assets and/or associated non-fungible tokens (NFT), the method 3000 may be configured to incorporate artificial intelligence (AI) or deep learning techniques, as described above. It should also be appreciated that, in some examples, the method 3000 may be implemented in conjunction with a content platform (e.g., a social media platform) to generate and deliver content.

Reference is now made with respect to FIG. 10. At 3010, the processor 101 may generate a virtual asset. In some examples, the processor 101 may utilize some or all of the candidate asset to generate the virtual asset, while in other examples, the processor 101 may not modify the candidate asset at all to generate the virtual asset. Also, in some examples, the processor 101 may generate variations of the candidate asset that may be used to create the virtual asset.

At 3020, the processor 101 may generate a non-fungible token (NFT) associated with a virtual asset. In some examples, the processor 101 may generated the non-fungible token (NFT) concurrently with the virtual asset. In other examples, the processor 101 may generate the non-fungible token (NFT) prior to generation of the virtual asset, or after generation of the virtual asset.

At 3030, the processor 101 may generate a contractual item to facilitate a transaction for a virtual asset and/or an associated non-fungible token (NFT). Examples of contractual items that may be generated include specifications, terms and conditions that may be utilized to facilitate a transaction of a virtual asset. In some examples, the processor 101 may further utilize a generated contractual item to generate a contract, such as a smart contract. In some examples, the smart contract may be implemented by the processor 101, and may provide ownership aspects and transactional aspects associated with the virtual asset.

At 3040, the processor 101 may generate an badge associated with a non-fungible token (NFT). In some examples, the badge generated via the processor 101 may be based on some or all of an associated virtual asset (e.g., using content from the virtual asset itself) and/or an associated non-fungible token (NFT). In some examples, the processor 101 may generate the badge to represent an ownership interest in the virtual asset, generate engagement around the virtual asset, and represent significant events or dates.

At 3050, in some examples, the processor 101 may generate an appraisal associated with a virtual asset and/or an associated non-fungible token (NFT). In particular, in some examples, the processor 101 may enable a user to provide an appraisal of a virtual asset to generate the appraisal of the virtual asset.

In some examples, the processor 101 may generate an engagement communication to a user that may enable to user to provide information (e.g., an appraisal) related to the virtual asset, and may receive information that may be associated with or may relate to an appraisal of the virtual asset. In some examples, the information related to the virtual asset received from the user may be utilized by the processor 101 for various purposes, including determining an appraisal score for the user or determining an valuation for a virtual asset. In some examples, the processor 101 may determine that a user to be prompted to provide an appraisal of a virtual asset, and may generate an appraisal score for a user based on various information.

In some examples, to engage the user, the processor 101 may generate an engagement communication related to a virtual asset. In some examples, an engagement communication generated via the processor 101 may be in a form of information package associated with the virtual asset. Also, in some examples, the processor 101 may generate an advertisement that may be published on a content platform (e.g., on a social media platform), and that may be engaged by a user to, among other things, receive information related to a virtual asset and provide various information related to an appraisal of a virtual asset. In some examples, the processor 101 may enable a user associated with a virtual asset to publish an engagement communication related to the virtual asset, and may calculate costs associated with publishing of an engagement communication and/or payments associated with a received appraisal with a projected purchase price of a virtual asset.

In some examples, the processor 101 may disburse a payment to an appraiser for a submitted appraisal received from a user. So, in some examples, the processor 101 may generate a disbursement scheme in order to incentivize aspects of appraisal generation. Examples of these aspects may include payments based on performance (i.e., accuracy) or loyalty (i.e., repeated and/or reliable submission of appraisals). In some examples, the processor 101 may disburse a payment based any transaction associated with the virtual asset.

In some examples, the processor 101 may generate a valuation for a virtual asset. Indeed, in some examples, the processor 101 may generate the valuation based on one or more (received) appraisals. In some examples, the processor 101 may utilize a smart contract associated with a virtual asset to generate a valuation of the virtual asset. Furthermore, in some examples, the processor 101 may adjust (e.g., continuously) the valuation based on various criteria, such as incoming appraisal values.

At 3060, in some examples, the processor 101 may facilitate a transaction associated with a virtual asset and/or an associated non-fungible token (NFT). In some examples, the processor 101 may implement various techniques, including artificial intelligence (AI), deep learning, and machine learning (ML) techniques, to match a first party (e.g., a seller) offering a virtual asset to a second party (e.g., a buyer) that may be interested. In some examples, the processor 101 may generate and implement an advertising plan to publish information related to the virtual asset and further determine if a party (e.g., a potential buyer) may be interested in the virtual asset. Furthermore, in some examples, the processor 101 may facilitate a conversion associated with the virtual asset. Examples of conversions associated with the virtual asset that may be implemented by the processor 101 may include purchases, downloads, sales, and responses.

Although the methods and systems as described herein may be directed mainly to digital content, such as videos or interactive media, it should be appreciated that the methods and systems as described herein may be used for other types of content or scenarios as well. Other applications or uses of the methods and systems as described herein may also include social networking, marketing, content-based recommendation engines, and/or other types of knowledge or data-driven systems.

It should be noted that the functionality described herein may be subject to one or more privacy policies, described below, enforced by the system 100, the external system 200, and the user devices 300A-B that may bar use of images for concept detection, recommendation, generation, and analysis.

In particular examples, one or more objects of a computing system may be associated with one or more privacy settings. The one or more objects may be stored on or otherwise associated with any suitable computing system or application, such as, for example, the system 100, the external system 200, and the user devices 300A-B, a social-networking application, a messaging application, a photo-sharing application, or any other suitable computing system or application. Although the examples discussed herein may be in the context of an online social network, these privacy settings may be applied to any other suitable computing system. Privacy settings (or “access settings”) for an object may be stored in any suitable manner, such as, for example, in association with the object, in an index on an authorization server, in another suitable manner, or any suitable combination thereof. A privacy setting for an object may specify how the object (or particular information associated with the object) can be accessed, stored, or otherwise used (e.g., viewed, shared, modified, copied, executed, surfaced, or identified) within the online social network. When privacy settings for an object allow a particular user or other entity to access that object, the object may be described as being “visible” with respect to that user or other entity. As an example and not by way of limitation, a user of the online social network may specify privacy settings for a user-profile page that identify a set of users that may access work-experience information on the user-profile page, thus excluding other users from accessing that information.

In particular examples, privacy settings for an object may specify a “blocked list” of users or other entities that should not be allowed to access certain information associated with the object. In particular examples, the blocked list may include third-party entities. The blocked list may specify one or more users or entities for which an object is not visible. As an example and not by way of limitation, a user may specify a set of users who may not access photo albums associated with the user, thus excluding those users from accessing the photo albums (while also possibly allowing certain users not within the specified set of users to access the photo albums). In particular examples, privacy settings may be associated with particular social-graph elements. Privacy settings of a social-graph element, such as a node or an edge, may specify how the social-graph element, information associated with the social-graph element, or objects associated with the social-graph element can be accessed using the online social network. As an example and not by way of limitation, a particular concept node corresponding to a particular photo may have a privacy setting specifying that the photo may be accessed only by users tagged in the photo and friends of the users tagged in the photo. In particular examples, privacy settings may allow users to opt in to or opt out of having their content, information, or actions stored/logged by the system 100, the external system 200, and the user devices 300A-B, or shared with other systems. Although this disclosure describes using particular privacy settings in a particular manner, this disclosure contemplates using any suitable privacy settings in any suitable manner.

In particular examples, the system 100, the external system 200, and the user devices 300A-B may present a “privacy wizard” (e.g., within a webpage, a module, one or more dialog boxes, or any other suitable interface) to the first user to assist the first user in specifying one or more privacy settings. The privacy wizard may display instructions, suitable privacy-related information, current privacy settings, one or more input fields for accepting one or more inputs from the first user specifying a change or confirmation of privacy settings, or any suitable combination thereof. In particular examples, the system 100, the external system 200, and the user devices 300A-BA-B may offer a “dashboard” functionality to the first user that may display, to the first user, current privacy settings of the first user. The dashboard functionality may be displayed to the first user at any appropriate time (e.g., following an input from the first user summoning the dashboard functionality, following the occurrence of a particular event or trigger action). The dashboard functionality may allow the first user to modify one or more of the first user's current privacy settings at any time, in any suitable manner (e.g., redirecting the first user to the privacy wizard).

Privacy settings associated with an object may specify any suitable granularity of permitted access or denial of access. As an example and not by way of limitation, access or denial of access may be specified for particular users (e.g., only me, my roommates, my boss), users within a particular degree-of-separation (e.g., friends, friends-of-friends), user groups (e.g., the gaming club, my family), user networks (e.g., employees of particular employers, students or alumni of particular university), all users (“public”), no users (“private”), users of third-party systems, particular applications (e.g., third-party applications, external websites), other suitable entities, or any suitable combination thereof. Although this disclosure describes particular granularities of permitted access or denial of access, this disclosure contemplates any suitable granularities of permitted access or denial of access.

In particular examples, different objects of the same type associated with a user may have different privacy settings. Different types of objects associated with a user may have different types of privacy settings. As an example and not by way of limitation, a first user may specify that the first user's status updates are public, but any images shared by the first user are visible only to the first user's friends on the online social network. As another example and not by way of limitation, a user may specify different privacy settings for different types of entities, such as individual users, friends-of-friends, followers, user groups, or corporate entities. As another example and not by way of limitation, a first user may specify a group of users that may view videos posted by the first user, while keeping the videos from being visible to the first user's employer. In particular examples, different privacy settings may be provided for different user groups or user demographics.

In particular examples, the system 100, the external system 200, and the user devices 300A-BA-B may provide one or more default privacy settings for each object of a particular object-type. A privacy setting for an object that is set to a default may be changed by a user associated with that object. As an example and not by way of limitation, all images posted by a first user may have a default privacy setting of being visible only to friends of the first user and, for a particular image, the first user may change the privacy setting for the image to be visible to friends and friends-of-friends.

In particular examples, privacy settings may allow a first user to specify (e.g., by opting out, by not opting in) whether the system 100, the external system 200, and the user devices 300A-BA-B may receive, collect, log, or store particular objects or information associated with the user for any purpose. In particular examples, privacy settings may allow the first user to specify whether particular applications or processes may access, store, or use particular objects or information associated with the user. The privacy settings may allow the first user to opt in or opt out of having objects or information accessed, stored, or used by specific applications or processes. The system 100, the external system 200, and the user devices 300A-BA-B may access such information in order to provide a particular function or service to the first user, without the system 100, the external system 200, and the user devices 300A-BA-B having access to that information for any other purposes. Before accessing, storing, or using such objects or information, the system 100, the external system 200, and the user devices 300A-BA-B may prompt the user to provide privacy settings specifying which applications or processes, if any, may access, store, or use the object or information prior to allowing any such action. As an example and not by way of limitation, a first user may transmit a message to a second user via an application related to the online social network (e.g., a messaging app), and may specify privacy settings that such messages should not be stored by the system 100, the external system 200, and the user devices 300A-B.

In particular examples, a user may specify whether particular types of objects or information associated with the first user may be accessed, stored, or used by the system 100, the external system 200, and the user devices 300A-B. As an example and not by way of limitation, the first user may specify that images sent by the first user through the system 100, the external system 200, and the user devices 300A-B may not be stored by the system 100, the external system 200, and the user devices 300A-B. As another example and not by way of limitation, a first user may specify that messages sent from the first user to a particular second user may not be stored by the system 100, the external system 200, and the user devices 300A-B. As yet another example and not by way of limitation, a first user may specify that all objects sent via a particular application may be saved by the system 100, the external system 200, and the user devices 300A-B.

In particular examples, privacy settings may allow a first user to specify whether particular objects or information associated with the first user may be accessed from the system 100, the external system 200, and the user devices 300A-B. The privacy settings may allow the first user to opt in or opt out of having objects or information accessed from a particular device (e.g., the phone book on a user's smart phone), from a particular application (e.g., a messaging app), or from a particular system (e.g., an email server). The system 100, the external system 200, and the user devices 300A-B may provide default privacy settings with respect to each device, system, or application, and/or the first user may be prompted to specify a particular privacy setting for each context. As an example and not by way of limitation, the first user may utilize a location-services feature of the system 100, the external system 200, and the user devices 300A-B to provide recommendations for restaurants or other places in proximity to the user. The first user's default privacy settings may specify that the system 100, the external system 200, and the user devices 300A-B may use location information provided from one of the user devices 300A-B of the first user to provide the location-based services, but that the system 100, the external system 200, and the user devices 300A-B may not store the location information of the first user or provide it to any external system. The first user may then update the privacy settings to allow location information to be used by a third-party image-sharing application in order to geo-tag photos.

In particular examples, privacy settings may allow a user to specify whether current, past, or projected mood, emotion, or sentiment information associated with the user may be determined, and whether particular applications or processes may access, store, or use such information. The privacy settings may allow users to opt in or opt out of having mood, emotion, or sentiment information accessed, stored, or used by specific applications or processes. The system 100, the external system 200, and the user devices 300A-B may predict or determine a mood, emotion, or sentiment associated with a user based on, for example, inputs provided by the user and interactions with particular objects, such as pages or content viewed by the user, posts or other content uploaded by the user, and interactions with other content of the online social network. In particular examples, the system 100, the external system 200, and the user devices 300A-B may use a user's previous activities and calculated moods, emotions, or sentiments to determine a present mood, emotion, or sentiment. A user who wishes to enable this functionality may indicate in their privacy settings that they opt in to the system 100, the external system 200, and the user devices 300A-B receiving the inputs necessary to determine the mood, emotion, or sentiment. As an example and not by way of limitation, the system 100, the external system 200, and the user devices 300A-B may determine that a default privacy setting is to not receive any information necessary for determining mood, emotion, or sentiment until there is an express indication from a user that the system 100, the external system 200, and the user devices 300A-B may do so. By contrast, if a user does not opt in to the system 100, the external system 200, and the user devices 300A-B receiving these inputs (or affirmatively opts out of the system 100, the external system 200, and the user devices 300A-B receiving these inputs), the system 100, the external system 200, and the user devices 300A-B may be prevented from receiving, collecting, logging, or storing these inputs or any information associated with these inputs. In particular examples, the system 100, the external system 200, and the user devices 300A-B may use the predicted mood, emotion, or sentiment to provide recommendations or advertisements to the user. In particular examples, if a user desires to make use of this function for specific purposes or applications, additional privacy settings may be specified by the user to opt in to using the mood, emotion, or sentiment information for the specific purposes or applications. As an example and not by way of limitation, the system 100, the external system 200, and the user devices 300A-B may use the user's mood, emotion, or sentiment to provide newsfeed items, pages, friends, or advertisements to a user. The user may specify in their privacy settings that the system 100, the external system 200, and the user devices 300A-B may determine the user's mood, emotion, or sentiment. The user may then be asked to provide additional privacy settings to indicate the purposes for which the user's mood, emotion, or sentiment may be used. The user may indicate that the system 100, the external system 200, and the user devices 300A-B may use his or her mood, emotion, or sentiment to provide newsfeed content and recommend pages, but not for recommending friends or advertisements. The system 100, the external system 200, and the user devices 300A-B may then only provide newsfeed content or pages based on user mood, emotion, or sentiment, and may not use that information for any other purpose, even if not expressly prohibited by the privacy settings.

In particular examples, privacy settings may allow a user to engage in the ephemeral sharing of objects on the online social network. Ephemeral sharing refers to the sharing of objects (e.g., posts, photos) or information for a finite period of time. Access or denial of access to the objects or information may be specified by time or date. As an example and not by way of limitation, a user may specify that a particular image uploaded by the user is visible to the user's friends for the next week, after which time the image may no longer be accessible to other users. As another example and not by way of limitation, a company may post content related to a product release ahead of the official launch, and specify that the content may not be visible to other users until after the product launch.

In particular examples, for particular objects or information having privacy settings specifying that they are ephemeral, the system 100, the external system 200, and the user devices 300A-B may be restricted in its access, storage, or use of the objects or information. The system 100, the external system 200, and the user devices 300A-B may temporarily access, store, or use these particular objects or information in order to facilitate particular actions of a user associated with the objects or information, and may subsequently delete the objects or information, as specified by the respective privacy settings. As an example and not by way of limitation, a first user may transmit a message to a second user, and the system 100, the external system 200, and the user devices 300A-B may temporarily store the message in a content data store until the second user has viewed or downloaded the message, at which point the system 100, the external system 200, and the user devices 300A-B may delete the message from the data store. As another example and not by way of limitation, continuing with the prior example, the message may be stored for a specified period of time (e.g., 2 weeks), after which point the system 100, the external system 200, and the user devices 300A-B may delete the message from the content data store.

In particular examples, privacy settings may allow a user to specify one or more geographic locations from which objects can be accessed. Access or denial of access to the objects may depend on the geographic location of a user who is attempting to access the objects. As an example and not by way of limitation, a user may share an object and specify that only users in the same city may access or view the object. As another example and not by way of limitation, a first user may share an object and specify that the object is visible to second users only while the first user is in a particular location. If the first user leaves the particular location, the object may no longer be visible to the second users. As another example and not by way of limitation, a first user may specify that an object is visible only to second users within a threshold distance from the first user. If the first user subsequently changes location, the original second users with access to the object may lose access, while a new group of second users may gain access as they come within the threshold distance of the first user.

In particular examples, the system 100, the external system 200, and the user devices 300A-B may have functionalities that may use, as inputs, personal or biometric information of a user for user-authentication or experience-personalization purposes. A user may opt to make use of these functionalities to enhance their experience on the online social network. As an example and not by way of limitation, a user may provide personal or biometric information to the system 100, the external system 200, and the user devices 300A-B. The user's privacy settings may specify that such information may be used only for particular processes, such as authentication, and further specify that such information may not be shared with any external system or used for other processes or applications associated with the system 100, the external system 200, and the user devices 300A-B. As another example and not by way of limitation, the system 100, the external system 200, and the user devices 300A-B may provide a functionality for a user to provide voice-print recordings to the online social network. As an example and not by way of limitation, if a user wishes to utilize this function of the online social network, the user may provide a voice recording of his or her own voice to provide a status update on the online social network. The recording of the voice-input may be compared to a voice print of the user to determine what words were spoken by the user. The user's privacy setting may specify that such voice recording may be used only for voice-input purposes (e.g., to authenticate the user, to send voice messages, to improve voice recognition in order to use voice-operated features of the online social network), and further specify that such voice recording may not be shared with any external system or used by other processes or applications associated with the system 100, the external system 200, and the user devices 300A-B. As another example and not by way of limitation, the system 100, the external system 200, and the user devices 300A-B may provide a functionality for a user to provide a reference image (e.g., a facial profile, a retinal scan) to the online social network. The online social network may compare the reference image against a later-received image input (e.g., to authenticate the user, to tag the user in photos). The user's privacy setting may specify that such voice recording may be used only for a limited purpose (e.g., authentication, tagging the user in photos), and further specify that such voice recording may not be shared with any external system or used by other processes or applications associated with the system 100, the external system 200, and the user devices 300A-B.

In particular examples, changes to privacy settings may take effect retroactively, affecting the visibility of objects and content shared prior to the change. As an example and not by way of limitation, a first user may share a first image and specify that the first image is to be public to all other users. At a later time, the first user may specify that any images shared by the first user should be made visible only to a first user group. The system 100, the external system 200, and the user devices 300A-B may determine that this privacy setting also applies to the first image and make the first image visible only to the first user group. In particular examples, the change in privacy settings may take effect only going forward. Continuing the example above, if the first user changes privacy settings and then shares a second image, the second image may be visible only to the first user group, but the first image may remain visible to all users. In particular examples, in response to a user action to change a privacy setting, the system 100, the external system 200, and the user devices 300A-B may further prompt the user to indicate whether the user wants to apply the changes to the privacy setting retroactively. In particular examples, a user change to privacy settings may be a one-off change specific to one object. In particular examples, a user change to privacy may be a global change for all objects associated with the user.

In particular examples, the system 100, the external system 200, and the user devices 300A-B may determine that a first user may want to change one or more privacy settings in response to a trigger action associated with the first user. The trigger action may be any suitable action on the online social network. As an example and not by way of limitation, a trigger action may be a change in the relationship between a first and second user of the online social network (e.g., “un-friending” a user, changing the relationship status between the users). In particular examples, upon determining that a trigger action has occurred, the system 100, the external system 200, and the user devices 300A-B may prompt the first user to change the privacy settings regarding the visibility of objects associated with the first user. The prompt may redirect the first user to a workflow process for editing privacy settings with respect to one or more entities associated with the trigger action. The privacy settings associated with the first user may be changed only in response to an explicit input from the first user, and may not be changed without the approval of the first user. As an example and not by way of limitation, the workflow process may include providing the first user with the current privacy settings with respect to the second user or to a group of users (e.g., un-tagging the first user or second user from particular objects, changing the visibility of particular objects with respect to the second user or group of users), and receiving an indication from the first user to change the privacy settings based on any of the methods described herein, or to keep the existing privacy settings.

In particular examples, a user may need to provide verification of a privacy setting before allowing the user to perform particular actions on the online social network, or to provide verification before changing a particular privacy setting. When performing particular actions or changing a particular privacy setting, a prompt may be presented to the user to remind the user of his or her current privacy settings and to ask the user to verify the privacy settings with respect to the particular action. Furthermore, a user may need to provide confirmation, double-confirmation, authentication, or other suitable types of verification before proceeding with the particular action, and the action may not be complete until such verification is provided. As an example and not by way of limitation, a user's default privacy settings may indicate that a person's relationship status is visible to all users (e.g., “public”). However, if the user changes his or her relationship status, the system 100, the external system 200, and the user devices 300A-B may determine that such action may be sensitive and may prompt the user to confirm that his or her relationship status should remain public before proceeding. As another example and not by way of limitation, a user's privacy settings may specify that the user's posts are visible only to friends of the user. However, if the user changes the privacy setting for his or her posts to being public, the system 100, the external system 200, and the user devices 300A-B may prompt the user with a reminder of the user's current privacy settings of posts being visible only to friends, and a warning that this change will make all of the user's past posts visible to the public. The user may then be required to provide a second verification, input authentication credentials, or provide other types of verification before proceeding with the change in privacy settings. In particular examples, a user may need to provide verification of a privacy setting on a periodic basis. A prompt or reminder may be periodically sent to the user based either on time elapsed or a number of user actions. As an example and not by way of limitation, the system 100, the external system 200, and the user devices 300A-B may send a reminder to the user to confirm his or her privacy settings every six months or after every ten photo posts. In particular examples, privacy settings may also allow users to control access to the objects or information on a per-request basis. As an example and not by way of limitation, the system 100, the external system 200, and the user devices 300A-B may notify the user whenever an external system attempts to access information associated with the user, and require the user to provide verification that access should be allowed before proceeding.

What has been described and illustrated herein are examples of the disclosure along with some variations. The terms, descriptions, and figures used herein are set forth by way of illustration only and are not meant as limitations. Many variations are possible within the scope of the disclosure, which is intended to be defined by the following claims—and their equivalents—in which all terms are meant in their broadest reasonable sense unless otherwise indicated.

1. A system, comprising:
a processor; and
a memory storing instructions, which when executed by the processor, cause the processor to:
generate a virtual asset;
generate a non-fungible token (NFT) associated with the virtual asset;
determine a contractual item to facilitate a transaction for the virtual asset and the non-fungible token (NFT);
generate a badge associated with the non-fungible token (NFT);
receive an appraisal associated with the virtual asset;
generate a valuation for the virtual asset based on the appraisal; and
facilitate the transaction for the virtual asset and the non-fungible token (NFT) based on the valuation.

2. The system of claim 1, wherein the instructions cause the processor to gather and analyze information associated with a candidate asset to determine if the candidate asset is suitable for non-fungible token (NFT) generation.

3. The system of claim 1, wherein the instructions cause the processor to:
gather and analyze information related to an attribute associated with the candidate item; and
generate an attribute score based on the information related to the attribute.

4. The system of claim 1, wherein the instructions cause the processor to generate an engagement communication associated with the virtual asset.

5. The system of claim 1, wherein the instructions cause the processor to receive a response to the engagement communication including the appraisal associated with the virtual asset.

6. A method for transacting of virtual assets and associated non-fungible tokens (NFT), comprising:
generating a virtual asset;
generating a non-fungible token (NFT) associated with the virtual asset;
receive an appraisal associated with the virtual asset;
generate a valuation for the virtual asset based on the appraisal; and
facilitating a transaction for the virtual asset and the non-fungible token (NFT).

7. The method of claim 6, further comprising determining a contractual item to facilitate the transaction for the virtual asset and the non-fungible token (NFT).

8. The method of claim 6, further comprising generating a badge associated with the non-fungible token (NFT).

9. The method of claim 6, wherein generating the virtual asset includes generating one or more variations of the virtual asset.

10. The method of claim 6, further including enabling a modification to the virtual asset.

11. The method of claim 6, wherein receiving an appraisal associated with the virtual asset includes determining a user to be prompted to provide the appraisal associated with the virtual asset.

12. The method of claim 11, wherein receiving an appraisal associated with the virtual asset further includes generating an appraisal score for the user.

13. A non-transitory computer-readable storage medium having an executable stored thereon, which when executed instructs a processor to:
generate a virtual asset;
generate a non-fungible token (NFT) associated with the virtual asset;
generate a badge associated with the non-fungible token (NFT);
receive an appraisal associated with the virtual asset;
generate a valuation for the virtual asset based on the appraisal; and
facilitate a transaction for the virtual asset and the non-fungible token (NFT).

14. The non-transitory computer-readable storage medium of claim 13, wherein the executable when executed further instructs the processor to determine a cost associated with publishing of an engagement communication associated with the virtual asset.

15. The non-transitory computer-readable storage medium of claim 14, wherein the engagement communication associated with the virtual asset includes an information package associated with the virtual asset.

16. The non-transitory computer readable storage medium of claim 13, wherein the executable when executed further instructs the processor to generate a tag associated with the virtual asset.

17. The non-transitory computer-readable storage medium of claim 13, wherein the executable when executed further instructs the processor to disburse a payment associated with the appraisal associated with the virtual asset.

18. The non-transitory computer-readable storage medium of claim 13, wherein the executable when executed further instructs the processor to generate a disbursement scheme associated with the virtual asset.

19. The non-transitory computer-readable storage medium of claim 13, wherein the executable when executed further instructs the processor to facilitate a conversion associated with the virtual asset.

20. The non-transitory computer-readable storage medium of claim 19, wherein the conversion is one of a purchase, a download, a sale, or a response.
